(19) United States
(12) Patent Application Publication
(10) Pub. No.: US 2024/0059335 A1
(43) Pub. Date: Feb. 22, 2024

(54) Water Softener Device

(71) Applicants: Harvey Becker, Palatine, IL (US); Dayana Becker, Palatine, IL (US)

(72) Inventors: Harvey Becker, Palatine, IL (US); Dayana Becker, Palatine, IL (US)

(21) Appl. No.: 18/335,306

(22) Filed: Jun. 15, 2023

Related U.S. Application Data
(60) Provisional application No. 63/399,291, filed on Aug. 19, 2022.

(51) Int. Cl. B62B 3/10; C02F 1/68; B62B 5/00; B62B 5/06; B62B 3/02; B66F 9/19; B66F 9/16

(52) U.S. Cl. CPC B62B 3/106; C02F 1/687; B62B 5/00; B62B 5/067; B62B 3/02; B66F 9/19; B66F 9/16; B62B 2202/22

(57) ABSTRACT

A water softener device is disclosed. The device can carry, lift, and pour bags of salt into a water softener. The water softener device comprises a cradle component that comprises a base component for retaining a bag of salt, a plurality wheels, and a handle for pulling the cradle component. Further, the device comprises an A-frame component with a set of tracks for accepting the wheels from the cradle component. The A-frame component also comprises a motorized winch system which engages the cradle component to pull the cradle component and salt bag up the inclined A-frame component.

### CROSS-REFERENCE TO RELATED APPLICATION

The present application claims priority to, and the benefit of, U.S. Provisional Application No. 63/399,291, which was filed on Aug. 19, 2022, and is incorporated herein by reference in its entirety.

### FIELD OF THE INVENTION

The present invention relates generally to the field of water softener devices. More specifically, the present invention relates to a device that eliminates the need to manually carry, lift, and pour salt into a water softener. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in water softener devices. Generally, with water softeners, people are forced to pick up the salt bag and carry it to the water softener. People must put the bag down and tear off the small, perforated corner provided by the manufacturer. Then, the bag must be picked up again and lifted above the height of the water softener. A user would have to hold the malleable bag in place while pouring and hoping the small corner hole doesn't clog or the bag falls off the softener onto the floor. This can cause back issues and require visits to a doctor.

Generally, the brine tank of a water softener must be refilled with salt periodically so that new brine can be created by dissolving the salt in water in the brine tank. The salt is preferably in the form of pellets which are purchased in bags weighing 40 or 80 pounds. The brine tank is typically located in a basement area or garage. The salt bags are loaded through a removably covered opening on the top of the brine tank, which is generally at least three feet above the floor level. The bags of salt are either purchased in a store and brought home in a personal vehicle or may be delivered by a service. In either case, the bags typically are in a garage or other outside storage area until they are needed. Carrying these rather heavy bags (40 to 80 pounds each) down to the basement and then lifting them high enough to dump into the top of the brine tank can prove to be difficult for many, and nearly impossible for elderly homeowners.

Accordingly, there is a demand for an improved water softener device that eliminates the need to manually carry and lift heavy bags of salt. More particularly, there is a demand for a device that does not cause a user back pain due to the heavy lifting of salt bags.

Therefore, there exists a long-felt need in the art for a water softener device that eliminates the need to manually carry, lift, and pour salt into a water softener. There is also a long-felt need in the art for a water softener device that provides significant relief to users when refilling their water softener with salt. Further, there is a long-felt need in the art for a water softener device that works with any size bag of salt up to and including 50 pounds. Moreover, there is a long-felt need in the art for a device that comprises an A-frame component for lifting and pouring the salt bags into the softener. Further, there is a long-felt need in the art for a water softener device that comprises a cradle component on wheels for retrieving and holding the salt bags. Finally, there is a long-felt need in the art for a water softener device that is powered by a remote-control electric winch.

The subject matter disclosed and claimed herein, in one embodiment thereof, comprises a water softener device. The device can carry, lift, and pour bags of salt into a water softener. The water softener device comprises a cradle component that comprises a base component for retaining a bag of salt, a plurality wheels, and a handle for pulling the cradle component. Further, the device comprises an A-frame component with a set of tracks for accepting the wheels from the cradle component. The A-frame component also comprises a motorized winch system which engages the cradle component to pull the cradle component and salt bag up the inclined A-frame component to be dumped into the water softener.

Accordingly, the cradle component detaches from the A-frame component and is mounted on the plurality of wheels, which makes it self-standing and maneuverable. The A-frame component is positioned in front of the water softener. The cradle component is then rolled to the salt bag location and then the salt bag is lifted approximately nine inches onto the base component of the cradle component. The cradle component is then wheeled back to the A-frame component via the cradle component's handle. The cradle component is attached to a cable from the gearbox of pulleys at the top of the A-frame component. The cable is powered by a remote-control electric winch, which lifts the cradle component up the incline of the A-frame component and tilts the cradle component, such that the bag of salt pours into the water softener.

In this manner, the water softener device of the present invention accomplishes all of the foregoing objectives and provides users with a device that eliminates the need to manually transport salt bags for a water softener. The device helps a user lift and pour a salt bag. The device enables anyone to add salt to a water softener.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a water softener device. The device can carry, lift, and pour bags of salt into a water softener. The water softener device comprises a cradle component that comprises a base component for retaining a bag of salt, a plurality wheels, and a handle for pulling the cradle component. Further, the device comprises an A-frame component with a set of tracks for accepting the wheels from the cradle component. The A-frame component also comprises a motorized winch system which engages the cradle component to pull the cradle component and salt bag up the inclined A-frame component to be dumped into the water softener.

In one embodiment, the water softener device comprises a cradle component that comprises a base component for retaining a bag of salt. The base component is generally rectangular in shape but can be any suitable shape and size as is known in the art. Typically, the base component is sized and shaped to retain a standard bag of salt, ranging from 10 to 50 pounds.

In one embodiment, the cradle component comprises a plurality of wheels for easy transport of the bag of salt. Any suitable number of wheels can be utilized as is known in the art. Typically, some of the wheels will be fixed and some of the wheels will swivel. The wheels are generally aligned with the tracks on the A-frame component, such that the cradle component engages the track with one set of wheels on the ground and another set of wheels interact with the tracks to move up the tracks via the winch system.

In one embodiment, the cradle component comprises a handle for pulling the cradle component with the bag of salt. Typically, the handle is a retractable handle that can be extended and retracted, when needed.

In one embodiment, the cradle component comprises a plurality of anti-slip stoppers on the base component for preventing the salt bag from slipping off the cradle component when the cradle component is pivoted up toward the water softener. In another embodiment, the cradle component comprises a plurality of louvers or wedges which act to prevent the salt bag from slipping when pivoted toward the water softener.

In one embodiment, the water softener device comprises an A-frame component that comprises a front section and a back section secured together at one end in an A-shape configuration. Thus, the front section and the back section are tilted at an incline and secured at the top into the A-shape configuration. Typically, the front section of the A-frame component comprises a parallel set of components in a spaced-apart relation and the back section is typically a mirror of the front section but does not have to be. The A-frame component is sized and shaped to be able to easily pull the cable component up the A-frame via a winch system. Further, the A-frame component is of a sufficient weight to be able to pull the cable component and a bag of salt up the A-frame without tipping or falling over.

In one embodiment, the front section of the A-frame component comprises a set of tracks for accepting the wheels from the cradle component. The end of the tracks, near the top of the A-frame component, comprise stops for the wheels of the cradle component. Once the wheels engage the tracks, the wheels are pulled up the tracks until they encounter the stops, allowing the cradle component to pivot forward, dumping the contents of the salt bag into the water softener.

In one embodiment, the A-frame component comprises a motorized winch system which engages the cradle component to pull the cradle component and salt bag up the inclined A-frame component to be dumped into the water softener.

In one embodiment, the motorized winch system comprises a motor, a spindle for winding the winch cable up and down, a gearbox (and pulleys), and a remote control for controlling the direction of the winch. Specifically, the cradle component is secured to the A-frame component via a hook or other means. Then, two chains from the winch cable are secured to a pivot point (i.e., pin connection) on the cradle component to allow the cradle component to be pulled up the tracks via the wheels until they encounter the stop and then pivoted toward the water softener (i.e., brine tank) to dump the salt bag into the water softener.

Specifically, the winch system comprises an electric motor, a spindle coupled to and driven by the motor, and a winch cable wound around the spindle. The motor drives the spindle in either direction, as desired by the user. The winch cable is wound about the spindle such that rotation of the spindle either retracts or extends the winch cable thereon, as necessary. The free end of the winch cable may preferably include a hook attached thereto for attaching to the cradle component in any suitable manner. When not in use, the free end of the winch cable may be pulled inside of the A-frame and secured to prevent uncontrolled movement of the cable.

In one embodiment, the winch may be operated by a controller. The controller may be operatively connected to a switch. The switch may be physically attached to the controller, as by a cable, or may be remotely attached via a remote-control or other suitable device. The winch may be any suitable winch, many of which are commercially available, such as the Badland Winches 2500 LB Capacity ATV/UTV Winch, or the Rugged Ridge Extreme HD ATV/UTV Winch, for example.

In one embodiment, the motor is electrically coupled to a conventional power source via a power cord secured in a standard wall outlet.

In one embodiment, the motor is electrically coupled to a battery, such as a rechargeable battery.

In yet another embodiment, the water softener device comprises a plurality of indicia.

In operation, the cradle component detaches from the A-frame component and is mounted on the plurality of wheels, which makes it self-standing and maneuverable. The A-frame component is positioned in front of the water softener. The cradle component is then rolled to the salt bag location and then the salt bag is lifted approximately nine inches onto the base component of the cradle component. The cradle component is then wheeled back to the A-frame component via the cradle component's retractable handle. The cradle component is attached to a winch cable from the gearbox and pulleys secured on the A-frame component. The winch cable is then powered by a remote-control electric winch to allow the cradle component to be pulled up the tracks (i.e., the incline of the A-frame component) via the wheels until they encounter the stop and then the cradle component is pivoted toward the water softener (i.e., brine tank) to pour the salt bag into the water softener.

In yet another embodiment, a method of lifting and pouring a salt bag into a water softener with ease is disclosed. The method includes the steps of providing a water softener device comprising a cradle component and an A-frame component. The method also comprises detaching the cradle component from the A-frame component. Further, the method comprises inserting a bag of salt on the cradle component. The method comprises wheeling the cradle component to the A-frame component. The method also comprises attaching the cradle component to a cable of a winch system. Finally, the method comprises lifting the cradle component and emptying the bag of salt into the water softener via the winch system.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the water softener device of the present invention in accordance with the disclosed architecture;

FIG. 2 illustrates a side perspective view of one embodiment of the water softener device of the present invention showing the cradle component secured to the A-frame component in accordance with the disclosed architecture;

FIG. 3 illustrates a rear perspective view of one embodiment of the water softener device of the present invention showing the A-frame component in accordance with the disclosed architecture;

FIG. 4 illustrates a perspective view of one embodiment of the water softener device of the present invention showing the cradle component in accordance with the disclosed architecture;

FIG. 5 illustrates a side perspective view of one embodiment of the water softener device of the present invention in use in accordance with the disclosed architecture; and

FIG. 6 illustrates a flowchart showing the method of lifting and pouring a salt bag into a water softener with ease in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a water softener device that eliminates the need to manually carry, lift, and pour salt into a water softener. There is also a long-felt need in the art for a water softener device that provides significant relief to users when refilling their water softener with salt. Further, there is a long-felt need in the art for a water softener device that works with any size bag of salt up to and including 50 pounds. Moreover, there is a long-felt need in the art for a device that comprises an A-frame component for lifting and pouring the salt bags into the softener. Further, there is a long-felt need in the art for a water softener device that comprises a cradle component on wheels for retrieving and holding the salt bags. Finally, there is a long-felt need in the art for a water softener device that is powered by a remote-control electric winch.

The present invention, in one exemplary embodiment, is a novel water softener device. The device can carry, lift, and pour bags of salt into a water softener. The water softener device comprises a cradle component that comprises a base component for retaining a bag of salt, a plurality wheels, and a handle for pulling the cradle component. Further, the device comprises an A-frame component with a set of tracks for accepting the wheels from the cradle component. The A-frame component also comprises a motorized winch system which engages the cradle component to pull the cradle component and salt bag up the inclined A-frame component. The present invention also includes a novel method of lifting and pouring a salt bag into a water softener with ease. The method includes the steps of providing a water softener device comprising a cradle component and an A-frame component. The method also comprises detaching the cradle component from the A-frame component. Further, the method comprises inserting a bag of salt on the cradle component. The method comprises wheeling the cradle component to the A-frame component. The method also comprises attaching the cradle component to a cable of a winch system. Finally, the method comprises lifting the cradle component and emptying the bag of salt into the water softener via the winch system.

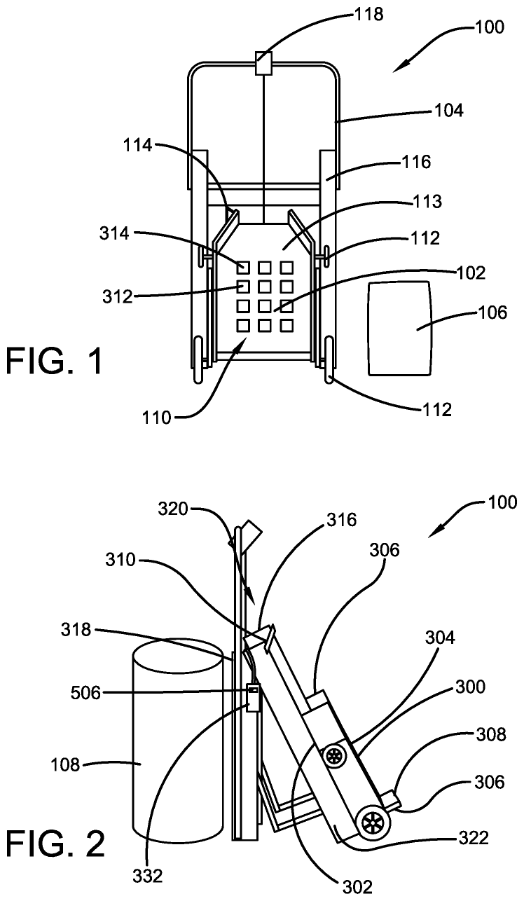

Referring initially to the drawings, FIGS. 1-2 illustrate a perspective view of one embodiment of the water softener device 100 of the present invention. In the present embodiment, the water softener device 100 is an improved water softener device 100 that eliminates the need to manually carry, lift, and pour salt bags 106 into a water softener 108. Specifically, the water softener device 100 comprises a cradle component 102 for retrieving and holding the salt bags 106 and an A-frame component 104 for lifting and pouring the salt bags 106 into the water softener 108. Specifically, the water softener device 100 comprises a cradle component 102 that comprises a base component 110 for retaining a bag 106 of salt, a plurality wheels 112, and a handle 114 for pulling the cradle component 102. Further, the device 100 comprises an A-frame component 104 with a set of tracks 116 for accepting the wheels 112 from the cradle component 102. The A-frame component 104 also comprises a motorized winch system 118 which engages the cradle component 102 to pull the cradle component 102 and salt bag 106 up the inclined A-frame component 104 to be poured into the water softener 108.

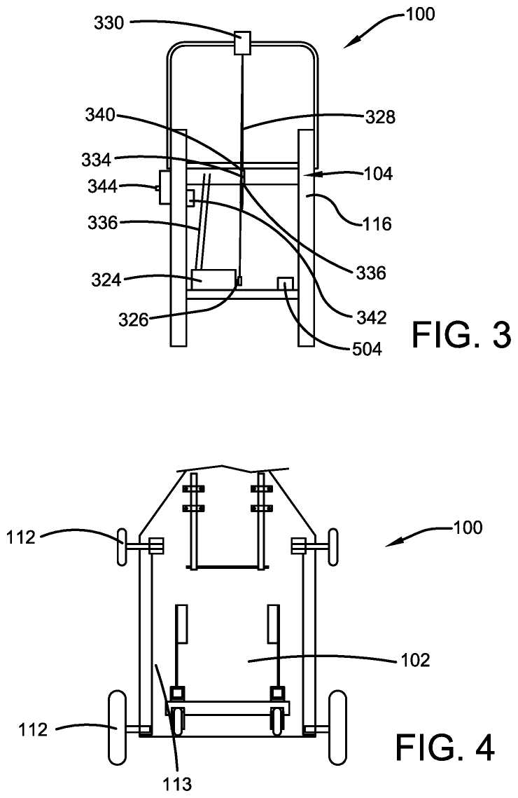

As shown in FIGS. 3-4, the water softener device 100 comprises a cradle component 102 that comprises a base component 110 for retaining a bag of salt 106. The base component 110 is generally rectangular in shape but can be any suitable shape and size as is known in the art. Typically, the base component 110 is sized and shaped to retain a standard bag 106 of salt, ranging from 10 to 50 pounds. Generally, the base component 110 only retains one standard bag 106 of salt, but in some embodiments, the base component 110 can be sized and shaped to retain multiple salt bags 106 at once.

Further, the base component 110 comprises a top surface 300, a bottom surface 302, right and left opposing sidewalls 304, and front and back opposing sidewalls 306. The base component 110 also comprises a lip 308 or other suitable structure, positioned at the foot of the base component 110 near the back opposing sidewall 306. The lip 308 acts to retain the salt bag 106 when the cradle component 102 is engaged with the tracks 116 and in an inclined position on the A-frame component 104. The lip 308 can be any suitable size as is known in the art, it can stretch across the entire back opposing sidewall 306 or be positioned only in the middle of the back opposing sidewall 306.

Additionally, the cradle component 102 comprises a plurality of wheels 112 for easy transport of the bag 106 of salt. Any suitable number of wheels 112 can be utilized as is known in the art. Typically, some of the wheels 112 will be fixed and some of the wheels 112 will swivel. The wheels 112 which swivel would rotate, swivel, and pivot in any direction, as needed. The plurality of wheels 112 can be secured to an underside 113 of the base component 110 via any suitable securing means as is known in the art, such as bolts, screws, pins, etc. Further, any suitable wheels 112 can be utilized as is known in the art, such as castors, rollers, swivel wheels, etc. In one embodiment, at least some of the plurality of wheels 112 are rugged, all-terrain wheels which help the device 100 travel over carpet or other rough flooring during use.

Further, the wheels 112 are generally aligned with the tracks 116 on the A-frame component 104, such that the cradle component 102 engages the track 116 with one set of wheels 112 on the ground and another set of wheels 112 interact with the tracks 116 to move up the tracks 116 via the winch system 118. Further, the end of each track 116 has a stop 310 which engages with the wheels 112 and acts to prevent the wheels 112 from moving up the tracks 116. Once the wheels 112 reach the stop 310, a pivot point is created which allows the cradle component 102 to be pivoted forward by the winch system 118 to pour the bag 106 of salt into the water softener 108.

Furthermore, the cradle component 102 comprises a handle 114 for pulling the cradle component 102 with the bag 106 of salt. Typically, the handle 114 is a retractable handle that can be extended and retracted, when needed. The handle 114 can be any suitable shape and size as is known in the art, depending on the needs and/or wants of a user. The handle 114 can be a bar-type handle, U-shaped handle, or merely an elongated rod. The handle 114 can also have an ergonomic or tread-like section to allow the user to safely and easily grasp the handle 114, even with wet hands.

Generally, the cradle component 102 also comprises a plurality of anti-slip stoppers 312 on the base component 110 for preventing the salt bag 106 from slipping off the cradle component 102 when the cradle component 102 is pivoted up toward the water softener 108. In another embodiment, the cradle component 102 comprises a plurality of louvers or wedges 314 which act to prevent the salt bag 106 from slipping when pivoted toward the water softener 108. Other suitable components can also be utilized to prevent slippage of the salt bag 106 when being poured into the water softener 108.

Furthermore, the water softener device 100 comprises an A-frame component 104 that comprises a front section 316 and a back section 318 secured together at one end 320 in an A-shape configuration. Thus, the front section 316 and the back section 318 are tilted at an incline and secured at the top 320 into the A-shape configuration. Typically, the front section 316 of the A-frame component 104 comprises a parallel set of components 322 in a spaced-apart relation and the back section 318 is typically a mirror of the front section 316 but does not have to be. The A-frame component 104 is sized and shaped to be able to easily pull the cradle component 102 up the A-frame 104 via a winch system 118. Further, the A-frame component 104 is of a sufficient weight to be able to pull the cradle component 102 and a bag 106 of salt up the A-frame 104 without tipping or falling over.

Additionally, the front section 316 of the A-frame component 104 comprises a set of tracks 116 for accepting the wheels 112 from the cradle component 102. Further, the end 320 of the tracks 116, near the top 320 of the A-frame component 104, comprise stops 310 for the wheels 112 of the cradle component 102. Each track 116 would have at least one stop 310 at the top 320 of the A-frame component 104. Once the wheels 112 engage the tracks 116, the wheels 112 are pulled up the tracks 116 until they encounter the stops 310 allowing the cradle component 102 to pivot forward, dumping the contents of the salt bag 106 into the water softener 108.

Furthermore, the A-frame component 104 comprises a motorized winch system 118 which engages the cradle component 102 to pull the cradle component 102 and salt bag 106 up the inclined A-frame component 104 to be dumped into the water softener 108. The winch system 118 can be any suitable motorized winch as is known in the art, depending on the needs and/or wants of a user. Further, any winch can be utilized, as long as the winch system 118 is sized and shaped to be able to easily pull the cradle component 102 with the salt bag 106 up an incline and then pivot the cradle component 102, such that the contents of the salt bag 106 pour into the water softener 108.

Generally, the motorized winch system 118 comprises a motor 324, a spindle 326 for winding the winch cable 328 up and down, a gearbox (and pulleys) 330, and a remote-control 332 for controlling the direction of the winch 118. Specifically, the cradle component 102 is secured to the A-frame component 104 via a hook 334 or other means. Then, two chains 336 or other suitable components from the winch cable 328 are secured to a pivot point (i.e., pin connection 338) on the cradle component 102 to allow the cradle component 102 to be pulled up the tracks 116 via the wheels 112 until they encounter the stops 310 and then the cradle component 102 is pivoted toward the water softener 108 (i.e., brine tank) to pour the contents of the salt bag 106 into the water softener 108.

Specifically, the winch system 118 comprises an electric motor 324, a spindle 326 coupled to and driven by the motor 324, and a winch cable 328 wound around the spindle 326. The motor 324 drives the spindle 326 in either direction, as desired by the user. The winch cable 328 is wound about the spindle 326, such that rotation of the spindle 326 either retracts or extends the winch cable 328 thereon, as necessary. The free end 340 of the winch cable 328 may preferably include a hook 334 attached thereto for attaching to the cradle component 102 in any suitable manner. When not in use, the free end 340 of the winch cable 328 may be pulled inside of the A-frame 104 and secured to prevent uncontrolled movement of the cable 328.

In one embodiment, the winch 318 may be operated by a controller 342. The controller 342 may be operatively connected to a switch 344. The switch 344 may be physically attached to the controller 342 by a cable or may be remotely attached via a remote-control 332 or other suitable device. The winch 318 may be any suitable winch, many of which are commercially available, such as the Badland Winches 2500 LB Capacity ATV/UTV Winch or the Rugged Ridge Extreme HD ATV/UTV Winch, for example.

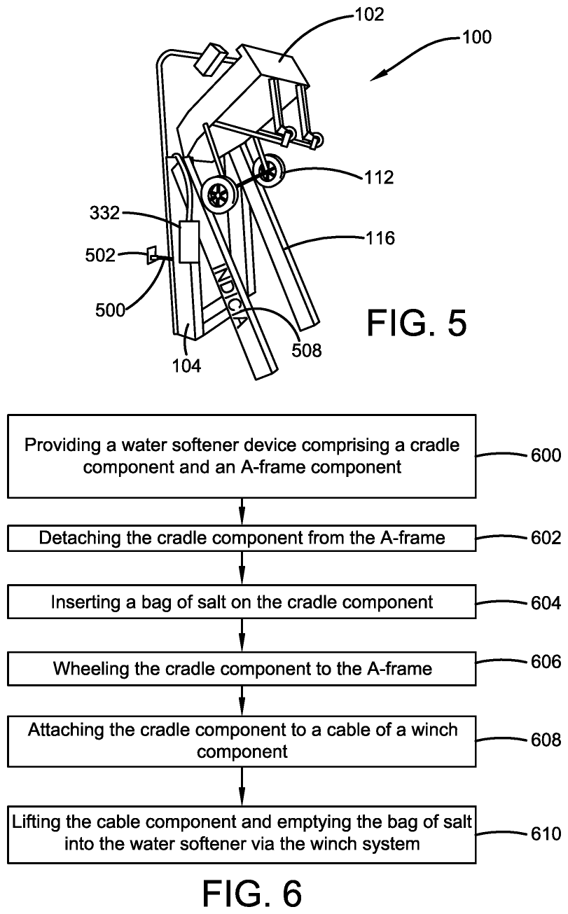

As shown in FIG. 5, the motor 324 is electrically coupled to a conventional power source via a power cord 500 secured in a standard wall outlet 502. In another embodiment, the motor 324 is electrically coupled to a battery 504, such as a rechargeable battery. The battery 504 may be a disposable battery or a rechargeable battery in the form of an alkaline, nickel-cadmium, nickel-metal hydride battery, etc., such as any 3V-12 volts DC battery or other conventional battery, such as A, AA, AAA, etc., that supplies power to the winch 118. Throughout this specification, the term “battery” may be used interchangeably to refer to one or more wet or dry cells or batteries of cells in which chemical energy is converted into electricity and used as a source of DC power. References to recharging or replacing the battery 504 may refer to recharging or replacing individual cells, individual batteries of cells, or a package of multiple battery cells as is appropriate for any given battery technology that may be used. In addition, a rechargeable embodiment of the battery 504 may be recharged using a USB port (not shown), wherein the USB port is a USB-A, USB-B, Micro-B, Micro-USB, Mini-USB, or USB-C port, etc.

Furthermore, the device 100 comprises multiple child safety devices to prevent children from being injured on or by the device 100. The device 100 also comprises an electric kill switch 506 to immediately kill power to the device 100, as needed in the event of an emergency.

In yet another embodiment, the water softener device 100 comprises a plurality of indicia 508. The base component 110 of the device 100 may include advertising, trademark, other letters, designs, or characters, printed, painted, stamped, or integrated into the base component 110, or any other indicia 508 as is known in the art. Specifically, any suitable indicia 508 as is known in the art can be included, such as, but not limited to, patterns, logos, emblems, images, symbols, designs, letters, words, characters, animals, advertisements, brands, etc., that may or may not be water softener, salt, or brand related.

In operation, the cradle component 102 detaches from the A-frame component 104 and is mounted on the plurality of wheels 112, which makes it self-standing and maneuverable. The A-frame component 104 is positioned in front of the water softener 108. The cradle component 102 is then rolled to the salt bag location and then the salt bag 106 is lifted approximately nine inches onto the base component 110 of the cradle component 102. The cradle component 102 is then wheeled back to the A-frame component 104 via the cradle component's retractable handle 114. The cradle component 102 is attached to a winch cable 328 from the gearbox 330 and pulleys secured on the A-frame component 104. The winch cable 328 is then powered by a remote-control 332 electric winch 118 to allow the cradle component 102 to be pulled up the tracks 116 (i.e., the incline of the A-frame component 104) via the wheels 112 until they encounter the stop 310 and then the cradle component 102 is pivoted toward the water softener 108 (i.e., brine tank), to pour the contents of the salt bag 106 into the water softener 108.

FIG. 6 illustrates a flowchart of the method of lifting and pouring a salt bag into a water softener with ease. The method includes the steps of at 600, providing a water softener device comprising a cradle component and an A-frame component. The method also comprises at 602, detaching the cradle component from the A-frame component. Further, the method comprises at 604, inserting a bag of salt on the cradle component. The method comprises at 606, wheeling the cradle component to the A-frame component. The method also comprises at 608, attaching the cradle component to a cable of a winch system. Finally, the method comprises at 610, lifting the cradle component and emptying the bag of salt into the water softener via the winch system.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “water softener device”, “softener device”, and “device” are interchangeable and refer to the water softener device 100 of the present invention.

Notwithstanding the foregoing, the water softener device 100 of the present invention can be of any suitable size and configuration as is known in the art without affecting the overall concept of the invention, provided that it accomplishes the above-stated objectives. One of ordinary skill in the art will appreciate that the water softener device 100 as shown in FIGS. 1-6 are for illustrative purposes only, and that many other sizes and shapes of the water softener device 100 are well within the scope of the present disclosure. Although the dimensions of the water softener device 100 are important design parameters for user convenience, the water softener device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A water softener device that eliminates the need to manually carry, lift and pour salt bags into a water softener, the water softener device comprising:
a cradle component; and
an A-frame component; and
wherein the cradle component comprises a base component for retaining a salt bag, a plurality of wheels and a handle for pulling the cradle component; and
further wherein the A-frame component comprises a set of tracks for accepting the plurality of wheels from the cradle component and a motorized winch which engages the cradle component to pull the cradle component and salt bag up the A-frame component to be poured into a water softener.

2. The water softener device of claim 1, wherein the base component comprises a top surface, a bottom surface, right and left opposing sidewalls, and front and back opposing sidewalls.

3. The water softener device of claim 2, wherein the base component comprises a lip positioned at a foot of the base component for retaining the salt bag within the cradle component.

4. The water softener device of claim 3, wherein the plurality of wheels can be fixed wheels and swivel wheels and are both secured to an underside of the base component.

5. The water softener device of claim 4, wherein the plurality of wheels are aligned with the set of tracks on the A-frame component, such that the cradle component slides up the set of tracks.

6. The water softener device of claim 5, wherein the set of tracks comprises a stop which prevents the plurality of wheels from moving up the set of tracks and allows the cradle component to be pivoted forward by the motorized winch to pour contents of the salt bag into the water softener.

7. The water softener device of claim 6, wherein the handle is a retractable handle.

8. The water softener device of claim 7 wherein the cradle component comprises a plurality of anti-slip stoppers on the base component for preventing the salt bag from slipping off the cradle component when the cradle component is pivoted up toward the water softener.

9. The water softener device of claim 8, wherein the A-frame component comprises a front section with the set of tracks and a back section secured together at a top in an inclined configuration.

10. The water softener device of claim 9, wherein the motorized winch comprises a motor, a spindle for winding a winch cable up and down which is coupled to and driven by the motor, a gearbox, and a remote-control for controlling direction of the motorized winch.

11. The water softener device of claim 10, wherein the cradle component is secured to the A-frame component via a hook on the winch cable and then two chains from the winch cable are secured to a pin connection on the cradle component, to allow the cradle component to be pulled up the set of tracks via the plurality of wheels until the stop is reached, then the cradle component is pivoted toward the water softener via the motorized winch, to pour the contents of the salt bag into the water softener.

12. The water softener device of claim 11, wherein the motor is electrically coupled to a conventional power source via a power cord secured in a standard wall outlet.

13. The water softener device of claim 11, wherein the motor is electrically coupled to a rechargeable battery.

14. The water softener device of claim 11 further comprising an electric kill switch.

15. A water softener device that eliminates the need to manually carry, lift, and pour salt bags into a water softener, the water softener device comprising:
a cradle component; and
an A-frame component; and
wherein the cradle component comprises a base component with a lip for retaining a salt bag, a plurality of swivel wheels and fixed wheels and a handle for pulling the cradle component; and
wherein the A-frame component comprises a set of tracks and a stop for accepting the plurality of swivel wheels and fixed wheels from the cradle component and a motorized winch which engages the cradle component to pull the cradle component and salt bag up the A-frame component to be poured into a water softener;
wherein the motorized winch comprises a motor, a spindle for winding a winch cable up and down which is coupled to and driven by the motor, a gearbox, and a remote-control for controlling direction of the motorized winch;
wherein the cradle component is secured to the A-frame component via a hook on the winch cable and then two chains from the winch cable are secured to a pin connection on the cradle component, to allow the cradle component to be pulled up the set of tracks via the plurality of swivel wheels and fixed wheels until the stop is reached, then the cradle component is pivoted toward the water softener via the motorized winch, to pour the contents of the salt bag into the water softener; and
further wherein the motor is electrically coupled to a conventional power source via a power cord secured in a standard wall outlet.

16. The water softener device of claim 15 further comprising a plurality of indicia.

17. The water softener device of claim 15 further comprising an electric kill switch.

18. The water softener device of claim 15, wherein the cradle component comprises a plurality of anti-slip stoppers on the base component for preventing the salt bag from slipping off the cradle component when the cradle component is pivoted up toward the water softener.

19. The water softener device of claim 15, wherein the handle is a retractable handle.

20. A method of lifting and pouring a salt bag into a water softener with ease, the method comprising the following steps:
providing a water softener device comprising a cradle component and an A-frame component;
detaching the cradle component from the A-frame component;
inserting a bag of salt on the cradle component;
wheeling the cradle component to the A-frame component;
attaching the cradle component to a cable of a winch system; and
lifting the cradle component and emptying the bag of salt into the water softener via the winch system.
